(19) United States
(12) Patent Application Publication
(10) Pub. No.: US 2004/0127216 A1
(43) Pub. Date: Jul. 1, 2004

(54) Electronic apparatus, radio communication apparatus, and dispatch electronic control method

(75) Inventor: Kazuya Fukushima, Hamura-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/730,938

(22) Filed: Dec. 10, 2003

(30) Foreign Application Priority Data
Dec. 25, 2002 (JP) 2002-374516

(51) Int. Cl. H04Q 7/20

(52) U.S. Cl. 455/432.2

(57) ABSTRACT

A base band unit of a radio communication module has basic functions for radio communications in accordance with a Bluetooth(R) protocol. Furthermore, the base band unit has a function of calculating the throughput of radio communications on the basis of a bit error rate (BER) and computing reception sensitivity on the basis of a signal-to-noise ratio (SNR). The base band unit monitors radio communications for their quality using the throughput calculated on the basis of the BER or the reception sensitivity computed on the basis of the SNR. If the base band unit determines that the communication quality is high, it instructs an RF unit to reduce dispatch power required to transmit data. On the other hand, if the base band unit determines that the communication quality is low, it instructs the RF unit to increase the dispatch power required to transmit data.

### CROSS-REFERENCE TO RELATED APPLICATIONS

This application is based upon and claims the benefit of priority from the prior Japanese Patent Application No. 2002-374516, filed Dec. 25, 2002, the entire contents of which are incorporated herein by reference.

### BACKGROUND OF THE INVENTION

1. Field of the Invention

The present invention relates to a power saving technique used during radio communications carried out in conformity with a radio communication standard such as IEEE802.11 or Bluetooth(R).

2. Description of the Related Art

In recent years, battery-driven portable personal computers have been popularized. Many of the recent personal computers of this kind comprise, for example, a radio communication module which is connected to a LAN or which transmits and receives data directly to and from other electronic apparatus.

Furthermore, in general, battery-driven electronic apparatus performs various power saving operations in order to make continuous battery-driven operation time as long as possible. These operations include power saving control carried out for radio communications using the previously described radio communication module (refer to, for example, the specification of U.S. Pat. No. 6,256,476).

In the telephone system described in the specification of U.S. Pat. No. 6,256,476, a master telephone monitors signals dispatched by a slave telephone for their quality. If the quality falls below a predetermined value, the master telephone instructs the slave telephone to increase power required to dispatch signals. Thus, the slave telephone basically transmits signals with a low dispatch power and increases the dispatch power as required. That is, this telephone system realizes power saving control which sets the dispatch power for the battery-driven slave telephone to an appropriate value in accordance with the situation.

In this connection, the telephone system described in the specification of U.S. Pat. No. 6,256,476 monitors signals dispatched by the slave telephone for their quality using an RSSI (Receive Signal Strength Indicator). That is, the system controls the signal dispatch power on the basis of the strength of signals. With this system, the master telephone and the slave telephone are assumed to execute radio communications in a stable environment, for example, inside the same room. Thus, the monitoring based on the RSSI creates almost no problems.

On the other hand, if an unspecified number of personal computers are connected to a wireless LAN installed in an unstable environment such as the outdoors, for example, in a station yard, an airport, or a restaurant, the signal dispatch power should be increased depending on the situation, even with a satisfactory RSSI value. However, in this case, incorrect control is likely to be provided by the power saving control method implemented by the telephone system described in the specification of U.S. Pat. No. 6,256,476.

### BRIEF SUMMARY OF THE INVENTION

According to an embodiment of the present invention, an electronic apparatus comprises a radio communication unit configured to carry out radio communications with external apparatus, a monitoring unit configured to monitor quality of radio communications carried out by the radio communication unit, and a control unit configured to control dispatch power for radio communications carried out by the radio communication unit on the basis of results of the monitoring executed by the monitoring unit.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of the invention.

FIG. 1 is a diagram showing the connection form of a network system according to a first embodiment of the present invention;

FIG. 2 is a diagram schematically showing the configuration of a personal computer according to the first embodiment;

FIG. 3 is a flow chart showing the operational procedure of power saving control carried out by a base band unit of a radio communication module mounted in the personal computer according to the first embodiment; and

FIG. 4 is a flow chart showing the operational procedure of power saving control carried out by a base band unit of a radio communication module mounted in an access point according to the first embodiment.

### DETAILED DESCRIPTION OF THE INVENTION

Embodiments of the present invention will be described with reference to the drawings.

### FIRST EMBODIMENT

First, a first embodiment of the present invention will be described.

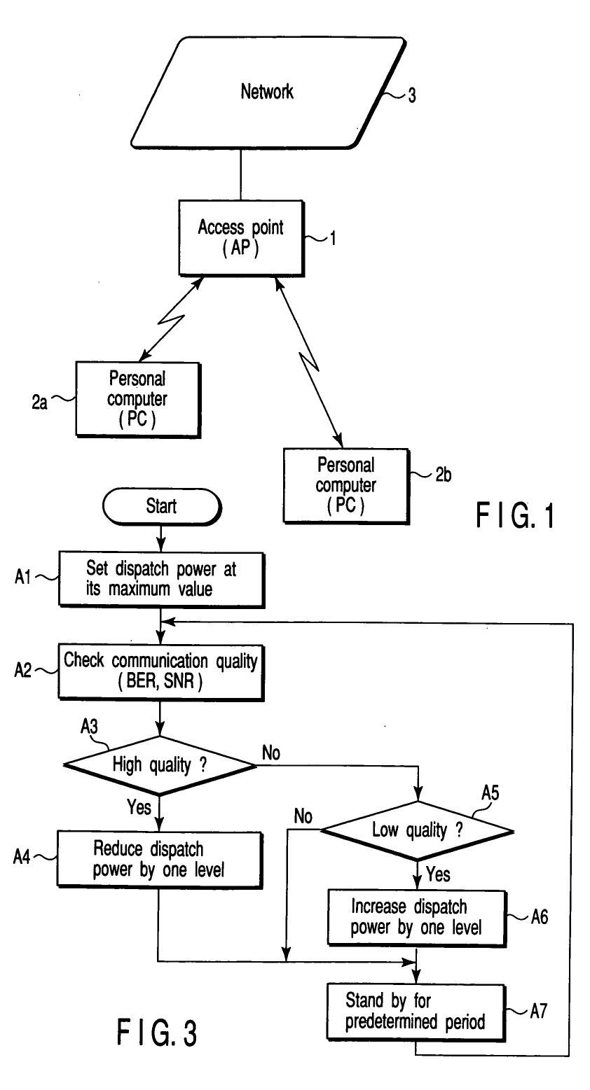

FIG. 1 is a diagram showing the connection form of a network system according to this embodiment of the present invention.

In the network system according to this embodiment, a plurality of personal computers (PC) 2a, 2b, . . . are connected to a network 3 via an access point (AP) 1 without any cables. Thus, both the access point 1 and the personal computers 2a, 2b, . . . are provided with a radio communication module that carries out radio communications in conformity with the Bluetooth(R) protocol. This network system is characterized in that each of the personal computers 2a, 2b, . . . controls its dispatch power for radio communications in order to save power. This will be described below in detail. In the description below, the personal computers 2a, 2b, . . . may be generally called a “personal computer 2”.

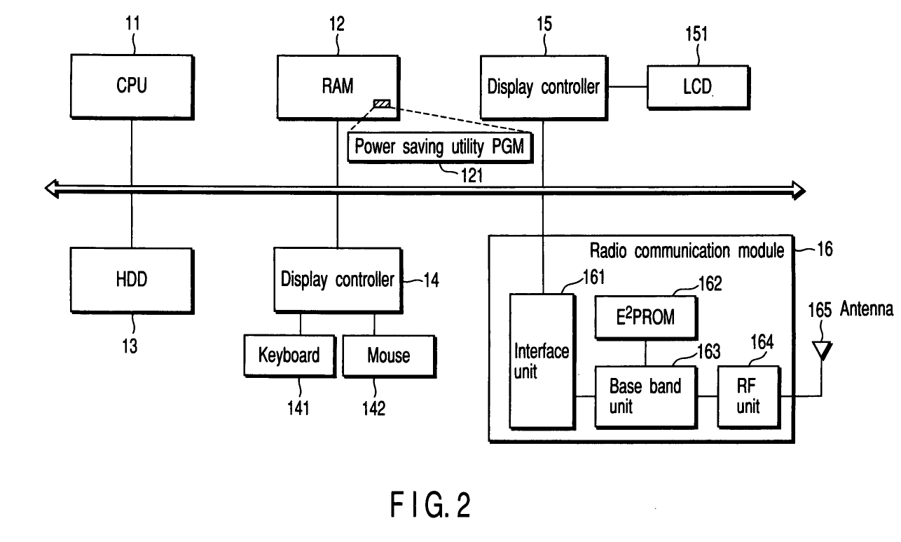

FIG. 2 is a diagram schematically showing the configuration of the personal computer 2.

The personal computer 2 is of, for example, a notebook type that can be driven by batteries. As shown in FIG. 2, a CPU 11, a RAM 12, an HDD 13, a keyboard controller 14, a display controller 15, and a radio communication module 16 are connected to a system bus.

The CPU 11 controls the whole personal computer 2 and executes various programs stored in the RAM 12. The RAM 12 is a storage medium used as a main storage for the personal computer 2 to store various programs executed by the CPU 11 and various data used for these programs. The programs stored in the RAM 12 include a power saving utility program 121, described later. On the other hand, the HDD 13 is s storage medium used as an external storage for the personal computer 2. The HDD 13 acts as an auxiliary device for the RAM 12 to store a large amount of various programs and data.

Furthermore, the keyboard controller 14 is a device working as an input side of a user interface of the personal computer 2. The keyboard controller 14 transmits the contents of operations performed on a keyboard 14 or a mouse 142. On the other hand, a display controller 15 is a device working as an output side of the user interface of the personal computer 2. The display controller 15 displays image data created by the CPU 11, on an LCD 151.

The radio communication module 16 carries out radio communications in conformity with the Bluetooth(R) protocol. The radio communication module 16 has an interface unit 161, an E²PROM 162, a base band unit 163, an RF unit 164, an antenna 165. The radio communication module 16 may be composed of a standard unit already contained in the personal computer 2 or an expanded unit housed in, for example, an expansion slot in the personal computer 2, as required.

The interface unit 161 is a bridge circuit used to incorporate the radio communication module 16 into the personal computer 2. The interface unit 161 loads commands or transmitted data from the CPU 11 and sends data received from the access point 1, out to the system bus. The E²PROM 162 is a storage medium to which set values that set an operating environment for the radio communication module 16 are saved.

The base band unit 163 has all basic functions for radio communications in accordance with the Bluetooth(R) protocol, for example, the functions of creating packets and determining a frequency hopping pattern. Furthermore, the base band unit 163 has a function of calculating the throughput of radio communications on the basis of a bit error rate (BER) and computing reception sensitivity on the basis of a signal-to-noise ratio (SNR). The current radio communication in operation can be monitored for its quality using the throughput calculated on the basis of the bit error rate (BER) or the reception sensitivity computed on the basis of the signal-to-noise ratio (SNR).

The RF (Radio Frequency) unit 164 dispatches transmitted data received from the base band unit 163, from the antenna 165, using a carrier with a frequency specified by the base band unit 163. The RF unit 164 also loads, through the antenna 165, received data superimposed on a carrier with a frequency specified by the base band unit 163, and delivers the data to the base band unit 163. Furthermore, the RF unit 164 has a function of switching dispatch power required to dispatch transmitted data from the antenna 165, among multiple levels in accordance with an instruction given by the base band unit 163.

As described previously, the base band unit 163 controls the power required by the RF unit 164 to dispatch transmitted data. Then, if the base band unit 163, monitoring radio communications for quality, determines that it is appropriate, it instructs the RF unit 164 to reduce the dispatch power for the transmitted data. On the other hand, if the base band unit 163 determines that radio communications are degraded, it instructs the RF unit 164 to increase the dispatch power for the transmitted data.

Specifically, the base band unit 163 thus controls the RF unit 164 to switch the dispatch power for radio communications on the basis of the current communication quality. Consequently, each personal computer 2 appropriately saves power without relying only on the strength of signals.

Furthermore, the base band unit 163 determines on the basis of the set values in the E²PROM 162 whether or not to execute the monitoring of radio communications for their quality and the switching control of the dispatch power based on the results of the monitoring. The power saving utility program 121 sets the values in the E²PROM 162. The power saving utility program 121 determines whether or not an external commercial power source is present, that is, whether or not the computer is driven by batteries. Then, if the computer is driven by batteries, the power saving utility program 121 makes settings required to cause the base band unit 163 to execute the monitoring and switching control.

FIG. 3 is a flow chart showing the operational procedure of power saving control executed by the base band unit 163.

When radio communication is started, the base band unit 163 first sets the dispatch power at its maximum value (step A1). Then, the base band unit 163 monitors the radio communication for its quality (step A2). If the quality is high (YES in step A3), the base band unit 163 changes the setting so as to reduce the dispatch power by one level (step A4).

On the other hand, if the quality is low (NO in step A3 and YES in step A5), the base band unit 163 changes the setting so as to increase the dispatch power by one level (step A6). That is, the base band unit 163 has two thresholds for an upper limit and a lower limit, respectively. It carries out switching so as to reduce the dispatch power if the BER or SNR has exceeded the upper limit. In contrast, it carries out switching so as to increase the dispatch power if the BER or SNR has exceeded the lower limit. If the BER and SNR are each within the range between the two thresholds (NO in step A3 and NO in step S5), the base band unit 163 maintains the current dispatch power.

After this series of operations, the base band unit 163 stands by for a predetermined time (step A7) and then repeats the process starting with step A2.

As described above, each personal computer 2 properly controls the dispatch power for radio communications on the basis of the communication quality, in order to save power.

### SECOND EMBODIMENT

Next, a second embodiment of the present invention will be described.

A network system according to the second embodiment differs from the network according to the previously described first embodiment in that in the network system according to the first embodiment, each personal computer 2 independently controls its dispatch power for radio communications, whereas in the network system according to the second embodiment, the access point executes unified control and instructs each personal computer 2 to change its dispatch power as required.

Specifically, the base band unit 163 mounted in at access point 1 monitors each personal computer 2 for the quality of a radio communication being executed by the computer. On the basis of the results of the monitoring, the base band unit 163 transmits control data required to change the dispatch power as required. The configuration of the apparatus of the access point 1 is almost the same as that of the personal computer 2, shown in FIG. 2. Accordingly, its description is omitted.

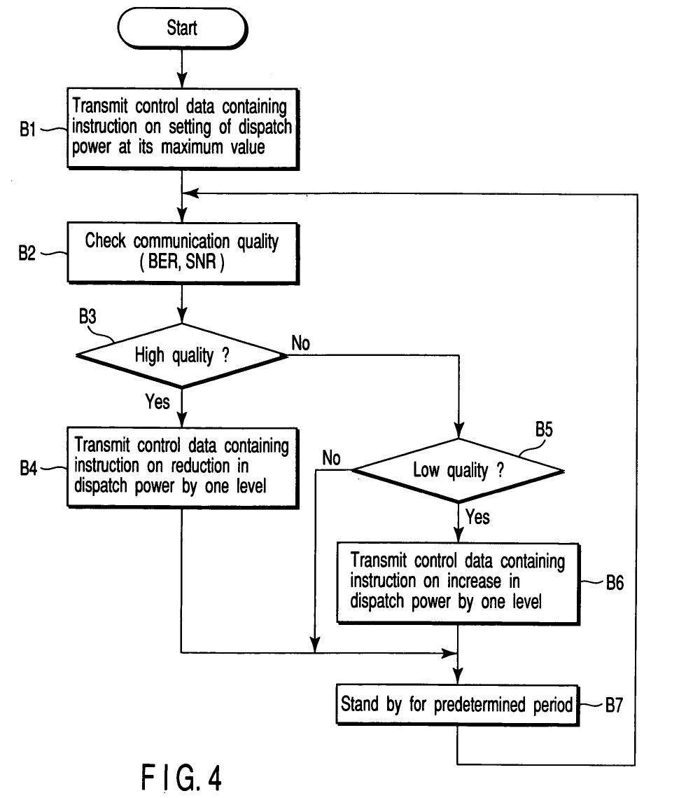

FIG. 4 is a flow chart showing the operational procedure of power saving control executed by the base band unit 163 of the access point 1 according to the second embodiment.

If any personal computer 2 starts radio communication with the access point 1, the base band unit 163 first transmits control data instructing the personal computer 2 to set the dispatch power at its maximum value (step B1). Then, the base band unit 163 monitors the radio communication with this personal computer 2 for its quality (step B2). If the quality is high (YES in step B3), the base band unit 163 transmits control data instructing the personal computer 2 to change the setting so as to reduce the dispatch power by one level (step B4).

On the other hand, if the quality is low (NO in step B3 and YES in step B5), the base band unit 163 transmits control data instructing the personal computer 2 to change the setting so as to increase the dispatch power by one level (step B6). That is, the base band unit 163 of the access point 1 has two thresholds for an upper limit and a lower limit, respectively. It carries out switching so as to reduce the dispatch power if the BER or SNR has exceeded the upper limit. In contrast, it carries out switching so as to increase the dispatch power if the BER or SNR has exceeded the lower limit. If the BER and SNR are each within the range between the two thresholds (NO in step B3 and NO in step B5), the base band unit 163 maintains the current dispatch power.

After the series of operations, the base band unit 163 stands by for a predetermined time (step B7) and then repeats the process starting with step B2.

As described above, under the control of the access point 1, each personal computer 2 properly controls the dispatch power for radio communications on the basis of the communication quality, in order to save power.

In the previously described examples of the first and second embodiments, the dispatch power for radio communications between the access point 1 and the personal computer 2 is controlled. However, the present invention is not limited to this aspect. When a plurality of personal computers 2 performs radio communications each other, the plurality of personal computers 2 may each execute control independently or one of them may independently control itself, while controlling the other.

Furthermore, in the description of the above example, the base band unit 163 of the radio communication module 16 controls the dispatch power for radio communications. However, this control may be executed by a program such as the power saving utility program 121 which is run by the CPU 11. This program gives instructions to the radio communication module 16 on the basis of the settings in the E²PROM 162.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus comprising:
a radio communication unit configured to carry out radio communications with external apparatus;
a monitoring unit configured to monitor quality of radio communications carried out by the radio communication unit; and
a control unit configured to control dispatch power for radio communications carried out by the radio communication unit on the basis of results of the monitoring executed by the monitoring unit.

2. The electronic apparatus according to claim 1, wherein the monitoring unit monitors the communication quality on the basis of throughput.

3. The electronic apparatus according to claim 1, wherein the monitoring unit calculates the throughput using a bit error rate (BER).

4. The electronic apparatus according to claim 1, wherein the monitoring unit monitors the communication quality on the basis of reception sensitivity.

5. The electronic apparatus according to claim 4, wherein the monitoring unit calculates the reception sensitivity using a signal-to-noise ratio (SNR).

6. The electronic apparatus according to claim 1, wherein the monitoring unit reduces the dispatch power, if the communication quality is high compared to a predetermined threshold.

7. An electronic apparatus having a radio communication function that carries out radio communications with an external apparatus, the electronic apparatus comprising:
a monitoring unit configured to monitor quality of radio communications carried out by the radio communication function; and
a control unit configured to transmit control data instructing the external apparatus to change dispatch power for the radio communication on the basis of results of the monitoring executed by the monitoring unit.

8. An electronic apparatus that can be operated using a commercial power source and a secondary battery, the electronic apparatus comprising:
a radio communication unit configured to carry out radio communications with external apparatus;
a determining unit configured to determine whether the external apparatus is operated using the commercial power source or the secondary battery;
a monitoring unit configured to monitor quality of radio communications carried out by the radio communication unit, if the determining unit determines that the external apparatus is operated using the secondary battery; and
a control unit configured to control dispatch power for radio communications which is outputted by the radio communication unit, on the basis of results of the monitoring executed by the monitoring unit.

9. The electronic apparatus according to claim 8, wherein the control unit reduces the dispatch power if the communication quality is high compared to a predetermined threshold.

10. The electronic apparatus according to claim 8, wherein the control unit increases the dispatch power if the communication quality is low compared to a predetermined threshold.

11. A radio communication apparatus applied to electronic apparatus, the radio communication apparatus comprising:
a monitoring unit configured to monitor a radio communication being executed for its quality; and
a control unit configured to control dispatch power for the radio communication on the basis of results of the monitoring executed by the monitoring unit.

12. The radio communication apparatus according to claim 11, wherein the monitoring unit monitors the communication quality on the basis of throughput.

13. The radio communication apparatus according to claim 12, wherein the monitoring unit calculates the throughput using a bit error rate (BER).

14. The radio communication apparatus according to claim 11, wherein the monitoring unit monitors the communication quality on the basis of reception sensitivity.

15. The radio communication apparatus according to claim 14, wherein the monitoring unit calculates the reception sensitivity using a signal-to-noise ratio (SNR).

16. A radio communication apparatus applied to electronic apparatus, the radio communication apparatus comprising:
a monitoring unit configured to monitor a radio communication being executed with an external apparatus for its quality; and
a control unit configured to transmit control data instructing the external apparatus to change dispatch power for the radio communication on the basis of results of the monitoring executed by the monitoring unit.

17. A method of controlling dispatch power for radio communications, the method comprising:
monitoring a radio communication being executed for its quality; and
controlling dispatch power for the radio communication on the basis of results of the monitoring.

18. A method of controlling dispatch power required by electronic apparatus having radio communication function, the method comprising:
determining whether the external apparatus is operated using a commercial power source or a secondary battery;
monitoring quality of radio communications carried out by the radio communication function, if the determining determines that the external apparatus is operated using the secondary battery; and
controlling dispatch power for radio communications which is outputted by the radio communication function, on the basis of results of the monitoring.
